(19) United States
(12) Patent Application Publication
(10) Pub. No.: US 2021/0091553 A1
(43) Pub. Date: Mar. 25, 2021

(54) WIRE BRACE

(71) Applicant: BOMBARDIER INC., Dorval (CA)

(72) Inventor: Martin ST-CYR, Laval (CA)

(21) Appl. No.: 16/630,011

(22) PCT Filed: Jul. 10, 2018
(86) PCT No.: PCT/CA2018/050836

§ 371 Date: Jan. 10, 2020

Related U.S. Application Data
(60) Provisional application No. 62/531,567, filed on Jul. 12, 2017.

(51) Int. Cl. H02G 11/00; F16L 3/015; B64D 47/00

(52) U.S. Cl. CPC H02G 11/00; B64D 2221/00; B64D 47/00; F16L 3/015

(57) ABSTRACT

A wire brace including two interconnected arms identical to each other, each having a first end having a first connection member, a second end opposed to the first end and having a second connection member complementary to the first connection member, and an engagement portion intermediate the first and second ends and including at least one tie member configured to surround and engage a wire. Also, a wire brace having first and second arms each with an engagement portion configured to be secured to a wire, and an end including a connection member. The connection members are removably engageable to each other in at least first and second alternate configurations; in the first configuration, the arms maintain a relative orientation at a first angle from each other, and in the second configuration, the arms maintain a relative orientation at a second angle different from the first angle.

### CROSS-REFERENCE TO RELATED APPLICATION(S)

This International PCT Patent Application relies for priority on U.S. Provisional Patent Application Ser. No. 62/531,567 filed on Jul. 12, 2017, the entire content of which is incorporated herein by reference.

### TECHNICAL FIELD

The application relates generally to the support of wires and, more particularly, to the support of wires having a bent position during use.

### BACKGROUND OF THE ART

In some instances, when wires are installed, a particular bend radius should be maintained to avoid damage to the wires. For example, in aircraft, wire manufacturers may require minimum values for bend radii of wires when installed. Also, wires may be already formed with a desired bend radius, so as to attempt to reduce the impact of the bend on the wire. However, it may be difficult to control the bend radius of each wire during the manufacture and installation.

Existing solutions to control the bend radius include fixed mechanical brackets attached to the aircraft, and to which the wires are attached upon installation. However, such brackets may add weight and/or complexity to the assembly. Moreover, it may still be possible to install a wire with an unacceptable bend radius upon assembly with the fixed brackets of the aircraft, depending on how the installation is performed.

### SUMMARY

In one aspect, there is provided a wire brace comprising: a first arm including a first engagement portion configured to be secured to a wire, the first arm having an end including a first connection member; a second arm including a second engagement portion configured to be secured to the wire, the second arm having an end including a second connection member complementary to the first connection member; wherein the first and second connection members are removably engageable to each other in at least first and second alternate configurations, wherein in the first configuration, the first and second arms maintain a relative orientation at a first angle from each other, and in the second configuration, the first and second arms maintain a relative orientation at a second angle from each other, the second angle being different from the first angle.

In particular embodiments, the wire brace may include any one or any combination of the following:
the first and second arms are identical to each other;
the first and second connection members are complementary shaped so as to define a non-rotatable engagement;
the first connection member is a female connection member and the second connection member is a male connection member, the male and female connection members having a polygonal shape;
the first arm has an opposed end including a third connection member identical to the second connection member of the second arm, and the second arm has an opposed end including a fourth connection member identical to the first connection member of the first arm;
an end link including a connection flange, the end link having an additional connection member removably engageable to the third connection member in at least first and second alternate link configurations, wherein in the first link configuration, the first arm maintains a relative orientation at a third angle from the connection flange, and in the second link configuration, the first arm maintains a relative orientation at a fourth angle from the connection flange, the third angle being different from the fourth angle;
the first engagement portion is defined by a portion of the first arm having at least two longitudinally spaced apertures extending therethrough, the second engagement portion is defined by a portion of the second arm having at least two longitudinally spaced apertures extending therethrough, the first and second engagement portions each further comprising a respective tie member looped through each aperture for surrounding the wire.

In a particular embodiment, an assembly includes the wire brace as defined above with the first and second connection members engaged to each other in the first configuration, and further comprising a wire secured to the first and second engagement portions, the wire brace maintaining a predetermined radius of curvature in a portion of the wire proximate the first and second connection members.

In another aspect, there is provided a wire brace including two arms connected to each other, the arms being identical to each other, each of the arms comprising: a first end having a first connection member; a second end opposed to the first end, the second end having a second connection member complementary to the first connection member; and an engagement portion intermediate the first and second ends, the engagement portion including at least one tie member configured to surround and engage a wire.

In a particular embodiment, the first connection member is a female connection member and the second connection member is a male connection member, the male and female connection members having a polygonal shape.

In a particular embodiment, each of the at least one tie member is looped through at least one respective aperture defined through the arm.

In a particular embodiment, the arms are directly connected to each other, the first connection member of a first one of the arms and the second connection member of a second one of the arms being removably engaged to each other with the arms maintaining a relative orientation at a first angle from each other, and wherein the first connection member of the first one of the arms and the second connection member of the second one of the arms are engageable to each other in an alternate configuration with the arms maintaining a relative orientation at a second angle from each other, the second angle being different from the first angle. The first and second connection members may be complementary shaped so as to define a non-rotatable engagement. The wire brace may further comprise an end link including a connection flange, the end link having an additional connection member removably engaged to the second connection member of the first one of the arms with the first one of the arms maintaining a relative orientation at a third angle from the connection flange, and wherein the end link is removably engageable to the second connection member of the first one of the arms in an alternate configuration with the first one of the arms maintaining a relative orientation at a fourth angle from the connection flange, the fourth angle being different from the third angle. An assembly may include the wire brace and further comprise a wire secured to the engagement portion of each one of the arms, the wire brace maintaining a predetermined radius of curvature in a portion of the wire proximate the first connection member of the first one of the arms and the second connection member of the second one of the arms.

In a particular embodiment, the arms are connected to each other via an intermediate link including third and fourth connection members spaced apart from each other, the third connection member being pivotally and removably engaged to the first connection member of a first one of the arms, the fourth connection member being pivotally and removably engaged to the second connection member of a second one of the arms, the intermediate link defining an articulated connection between the arms allowing a variation in a relative orientation of the arms. The wire brace may further comprise an end link including a connection flange, the end link having an additional connection member pivotally and removably engaged to the second connection member of the first one of the arms, wherein the end link is configured to define an articulated connection allowing a variation in a relative orientation of the first one of the arms with respect to the connection flange. The first connection member may be a female connection member and the second connection member may be a male connection member, the first and second connection members having a similar polygonal shape, and wherein the third connection member is a male connection member and the fourth connection member is a female connection member, the third and fourth connection members having a circular shape. An assembly may include the wire brace and further comprise a wire secured to the engagement portion of each of the arms so as to allow a relative sliding movement of the wire along a longitudinal axis of the wire, the wire having an overall length greater than a combined length of the arms and of the intermediate link, the wire defining a loop of extra wire material between the arms.

In another aspect, there is provided a method of maintaining a predetermined radius of curvature in a wire, the method comprising: preforming the wire to include a curved section having the predetermined radius of curvature, including engaging the wire to a brace maintaining the predetermined radius of curvature in a self-supporting manner; installing the wire while the wire remains engaged to the brace; and leaving the wire engaged to the brace during use of the wire.

In a particular embodiment, installing the wire includes attaching the brace to an element adjacent the installed wire.

### DESCRIPTION OF THE DRAWINGS

For a better understanding of the present invention, as well as other aspects and further features thereof, reference is made to the following description which is to be used in conjunction with the accompanying drawings, where:

FIG. 1 is a schematic tridimensional view of an aircraft in accordance with a particular embodiment;

FIG. 2a is a schematic side view of a wire brace in accordance with a particular embodiment;

FIG. 2b is a schematic opposed side view of the wire brace and wire of FIG. 2a, showing examples of engagement of the brace to a wire;

FIG. 3 is a schematic tridimensional view of arms of the wire brace of FIGS. 2a-2b, disengaged from each other;

FIG. 4 is a schematic tridimensional view of a male end link which may be used with the arms of FIG. 3, in accordance with a particular embodiment;

FIG. 5 is a schematic tridimensional view of a female end link which may be used with the arms of FIG. 3, in accordance with a particular embodiment;

FIG. 6 is a schematic tridimensional view of a pivotable end link which may be used with the arms of FIG. 3, in accordance with a particular embodiment;

FIG. 7 is a schematic tridimensional view of a pivotable intermediate link which may be used with the arms of FIG. 3, in accordance with a particular embodiment;

FIG. 8 is a schematic side view of a wire brace in accordance with a particular embodiment, including the arms of FIG. 3 and the end links of FIGS. 4-5, and in engagement with a wire;

FIG. 9 is a schematic tridimensional view of a wire brace in accordance with a particular embodiment, including the arms of FIG. 3, and the links of FIGS. 6-7, and in engagement with a wire;

FIG. 10 is a schematic tridimensional view of a wire brace in accordance with another particular embodiment.

### DETAILED DESCRIPTION

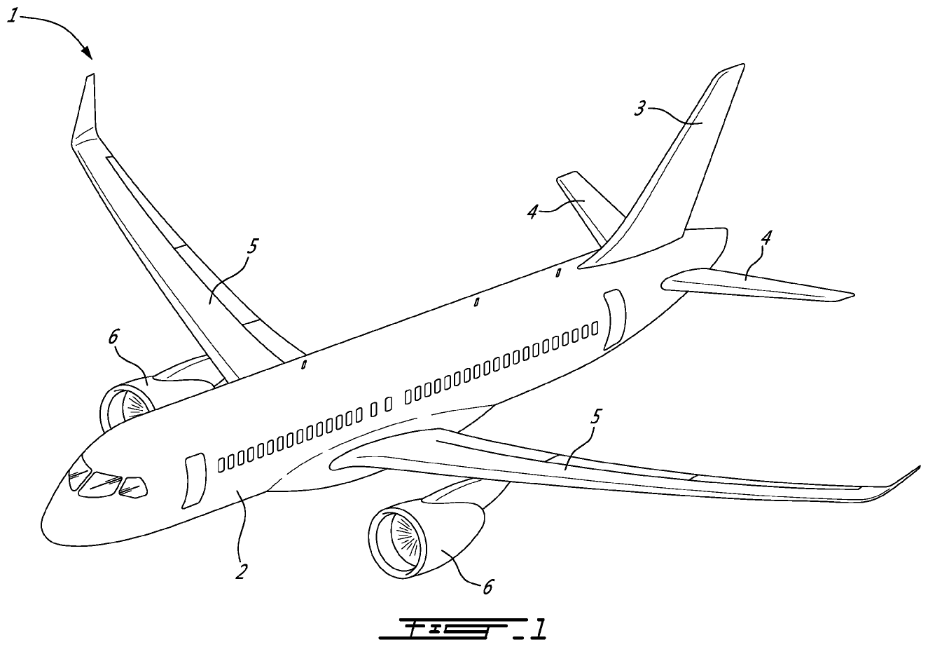

Referring to the drawings and more particularly to FIG. 1, an aircraft is shown at 1, and is generally described to illustrate some components for reference purposes in the present disclosure. The aircraft 1 has a fuselage 2 having a fore end at which a cockpit is located, and an aft end supporting a tail assembly, with the cabin generally located between the cockpit and the tail assembly. The tail assembly comprises a vertical stabilizer 3 with a rudder, and horizontal stabilizers 4 with elevators. The tail assembly has a fuselage-mounted tail, but other configurations may also be used for the aircraft 1, such as cruciform, T-tail, etc. Wings 5 project laterally from the fuselage. The aircraft 1 has engines 6 supported by the wings 5, although the engines 6 could also be mounted to the fuselage 2. The aircraft 1 is shown as a jet-engine aircraft, but may also be a propeller aircraft.

The aircraft 1 includes multiple wires interconnecting interacting systems, for example to transmit power and/or commands. It is understood that the term “wire” as used herein is intended to include, while not being limited to, electrical wires, fiber optic cables, wire harnesses, hydraulic lines, and any other type of flexible filament or tube used to transmit signals, light, electricity, fluid, etc. In a particular embodiment, the wires have a minimum bend radius which is determined by multiple factors, for example the type of wire, the structural supports available to support the wire once installed, the allowable stress on the wire and/or the allowable stress on the connectors of the wire. Each connector is typically engaged to a respective element of the aircraft (e.g. system, control panel, control unit, sensor).

When a wire is manufactured, a preforming step may be performed to position the wire in a bended (curved) state corresponding to the bent position of the wire after installation and during use; this preforming curves the wire at a radius larger to or equal to its minimum bend radius. This may be done, for example, by engaging the wire with a bending template. The wire however needs to be disengaged from the bending template before installation, and accordingly maintaining the bent configuration until, during, and/or after installation may be difficult.

The present disclosure provides for a wire brace which in a particular embodiment may replace the template during preforming of the wire. The wire brace however remains on the wire during installation and subsequent use. Accordingly, the wire brace allows for preforming of the wires during manufacturing, and for maintaining the performed shape during installation and subsequent use, so that the bent configuration of the wire with the curve(s) defined at a radius larger to or equal to its minimum bend radius is maintained at installation and during use, and for example throughout the life of the wire. This may increase the long term reliability of the wire by reducing or eliminating stress on the wire and/or connectors.

In another embodiment, the wire brace may provide a guide for service loops in the wire during movement of the wire after installation, for example for maintenance operations.

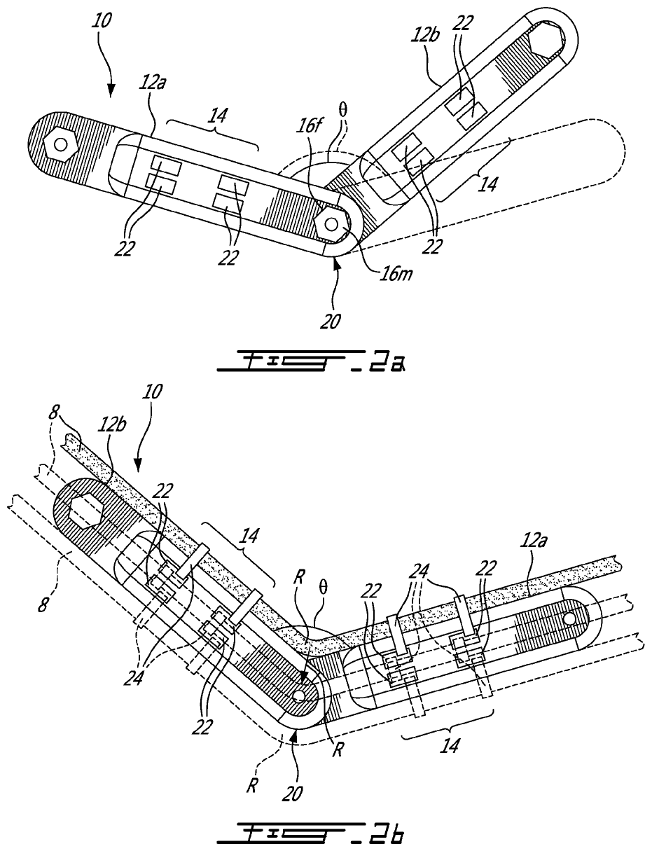

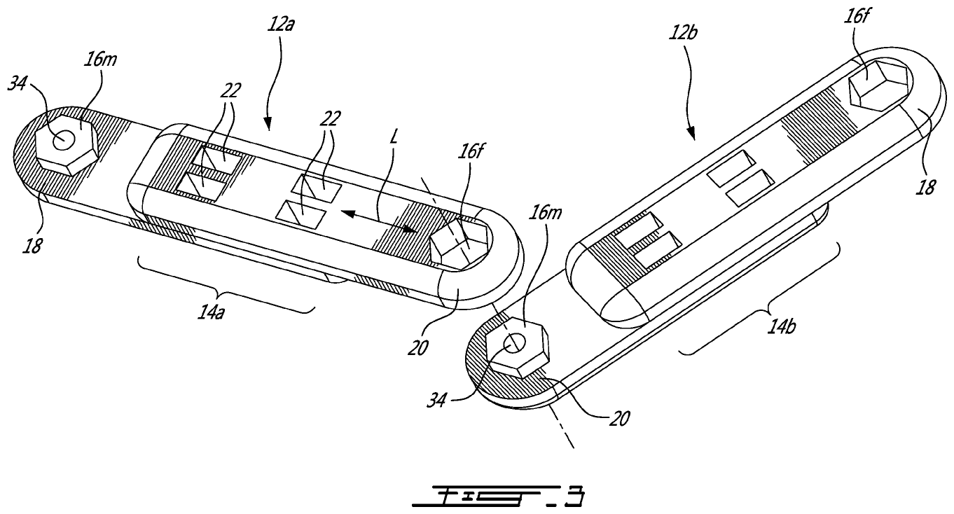

Referring to FIGS. 2a and 2b, a wire brace 10 in accordance with a particular embodiment is shown, illustrated in an assembly including a wire 8 in FIG. 2b. The wire brace 10 includes two arms 12a, 12b that are directly connected to each other. Each arm 12a, 12b includes an engagement portion 14 configured to be secured to the wire 8, and a connection member 16f, 16m (FIG. 2a) for engaging the other arm. The connection members 16f, 16m of the two arms 12a, 12b are thus complementary to each other.

In a particular embodiment, the arms 12a, 12b are made of nylon. It is however understood that any other suitable material may alternately be used, including, but not limited to, wood, suitable polymers, and suitable metals. The arms 12a, 12b are preferably made of a light weight material so as to minimize the weight impact of the use of the wire brace 10. In a particular embodiment, the wire brace 10 is lighter than prior fixed mechanical brackets attached to the aircraft structure and previously used to guide the wire and attempt to maintain its bent shape.

The connection members 16f, 16m are removably engageable with each other in at least two, and in a particular embodiment more than two, different configurations, with each configuration defining a different angle 8 between the two arms; an alternate configuration is illustrated by the dotted lines in FIG. 2a. In each configuration, the two arms 12a, 12b maintain the corresponding relative orientation and angle 8, i.e. the connection members 16f, 16m define a rigid, non-rotatable connection between the two arms 12a, 12b in a self-supporting manner.

Referring to FIG. 3, in a particular embodiment the connection member 16f of one of the arms 12a is a female connection member, and the connection member 16m of the other arm 12b is a male connection member snuggly receivable in the female connection member. Both connection members 16f, 16m have a polygonal shape, so as to prevent relative rotation of the male connection member within the female connection member. In the embodiment shown, the polygonal shape is an hexagon; other configurations are of course possible, depending on the number of possible different relative orientations desired for the two arms 12a, 12b and on the load applied by the wire 8 on the engagement between the connection members 16f, 16m. Alternately, a clutch or ratchet-type mechanism could be used to allow for adjustment of the relative orientation of the two arms 12a, 12b.

In the embodiment shown, and as can be best seen in FIG. 3, the two arms 12a, 12b are identical to each other; such may facilitate manufacturing and/or installation of the wire brace 10, by reducing the number of different parts forming the wire brace 10. Accordingly, each arm 12a, 12b has an additional connection member opposite the connection member engaged with the other arm. The male connection member 16m on the distal end 18 of the first arm 12a is identical to the male connection member 16m on the engaged end 20 of the second arm 12b, and the female connection member 16f of the distal end 18 of the second arm 12b is identical to the female connection member 16f on the engaged end 20 of the first arm 12a. Each arm 12a, 12b accordingly includes a male connection member 16m at one end and a female connection member 16f at the other end, with the connection members 16f, 16m of each arm being complementary to each other.

In the embodiment shown, each end 18, 20 has a reduced thickness with respect to the engagement portion 14, for example half the thickness of the engagement portion 14, and is configured so that when assembled, the outer surfaces of the arms 12a, 12b are aligned; accordingly, each arm 12a, 12b is substantially “Z” shaped.

In the embodiment shown, the engagement portion 14 of each arm 12a, 12b is defined by a portion of the arm intermediate the two ends 18, 20, which includes two pairs of apertures 22 defined therethrough; the pairs are spaced apart along a longitudinal direction L of the arm, while the apertures 22 of a same pair are spaced apart along a direction perpendicular to the longitudinal direction. Although apertures 22 with closed perimeters are shown, it is understood that alternately the apertures 22 may have an open perimeter, e.g. be defined as notches on a surface of the arms; more or less apertures could also be provided. Alternately, each pair of apertures 22 could be replaced by a single aperture.

Referring back to FIG. 2b, each engagement portion 14 further includes one or more tie members 24, each looped through one or both apertures 22 of a respective pair, for surrounding the wire 8 and retaining it against the arm 12a, 12b. In the embodiment shown in full lines, the wire 8 is received against the top surfaces of the arms, and each tie member 24 is looped through a single aperture 22 and around the wire 8 to maintain it in place. Alternately, and as shown in dotted lines, the wire 8 may be received against the bottom surfaces (e.g. with the tie members 24 each looped through a single aperture 22 as shown), or against one of the side surfaces through which the apertures are defined; in this embodiment, each tie member 24 may be looped through both apertures 22 of a same pair (as shown) to position the wire substantially between the apertures 22 of a same pair, or be looped through a single aperture, for example similarly to the embodiment shown in full lines. It is understood that any other suitable manner of attachment may alternately be used, and that multiple wires may also be simultaneously engaged to the brace 10.

Each tie member 24 may be any suitable type of tie member, including, but not limited to, a cable tie having a tape section with teeth engaging a pawl in a head at the opposed end so as to form a ratchet connection, a heat shrink sleeve, a lacing cord, etc. The tie member may engage the wire 8 in a removable/detachable manner, or alternately may engage the wire 8 in a permanent manner, i.e. a manner necessitating breaking of the tie member 24 and/or the arm 12a, 12b to detach the wire 8 from the arm 12a, 12b.

Still referring to FIG. 2b, the wire brace 10 engaged to the wire 8 maintains a predetermined radius of curvature R in a portion of the wire 8 proximate the engaged ends 20 of the arms 12a, 12b; the radius of curvature R is determined by the angle maintained between the two arms 12a, 12b. The wire brace 10 is self-supporting, in that the arms 12a, 12b maintain their relative orientation (angle 8) without the need for additional support structure (e.g., without the need to be connected to a fixed bracket attached to the aircraft structure). In a particular embodiment, the tie members 24 surround/engage the wire 8 in a tight enough manner to prevent or at least impede movement of the wire relative to the arms 12a, 12b along the longitudinal axis of the wire 8, so that the radius of curvature R can be maintained. The wire brace 10 may be attached to the wire 8 during preforming, and remain attached to the wire 8 throughout installation and use. Since the arms 12a, 12b maintain the selected relative orientation, the radius of curvature R of the wire 8 is maintained throughout installation and use.

Although only two interconnected arms 12a, 12b are shown, it is understood that the wire brace 10 may alternately include more than two interconnected arms 12a, 12b. The wire brace may include additional members engaged to the arms 12a, 12b, for example engaged to one or both of the arms 12a, 12b at their distal end 18, or defining the connection between the two arms 12a, 12b, as will be further detailed below.

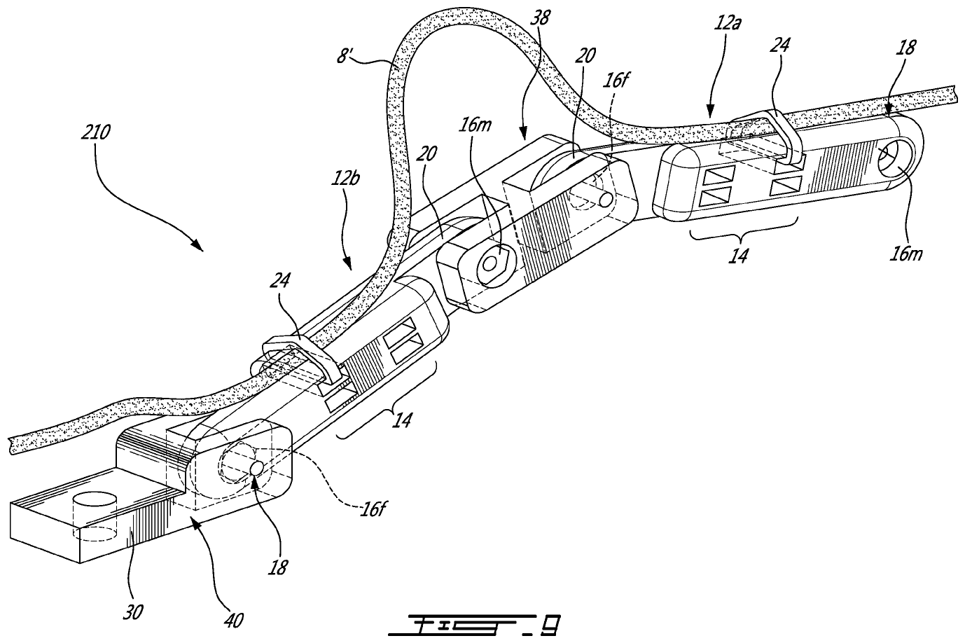

Referring to FIG. 8, in a particular embodiment the wire brace 110 includes the two arms 12a, 12b directly connected to each other, as described for the wire brace 10 of FIGS. 2a-2b. In this embodiment however, the wire brace 110 further includes end links 26, 28, each one connected to the distal end 18 of a respective one of the arms 12a, 12b. Each of the end links 26, 28 includes a connection flange 30 configured for engagement to a respective element of the aircraft (e.g. element adjacent the installed wire, including, but not limited to, element the installed wire is connected to), and an additional connection member 17f, 17m removably connected to the respective arm 12a, 12b.

In the embodiment shown where the two arms 12a, 12b are identical, the first arm 12a (rightmost arm in the Figure) has its female connection member 16f engaged with the male connection member 16m of the second arm 12b. The distal end 18 of the first arm 12a accordingly includes a male connection member 16m; the end link 28 connected to the first arm 12a is thus a female end link, including a female connection member 17f snuggly receiving the male connection member 16m of the first arm 12a. The distal end 18 of the second arm 12b includes a female connection member 16f; the end link 26 connected to the second arm 12b is thus a male end link, including a male connection member 17m snuggly received in the female connection member 16f of the second arm 12b.

Each end link 26, 28 is removably engageable with the respective arm 12a, 12b in at least two, and in a particular embodiment more than two, different configurations, with each configuration defining a different angle 6 between the arm 12a, 12b and the connection flange 30 of the respective end link 26, 28 (and accordingly, the element of the aircraft that the link is engaged to). In each configuration, the arm 12a, 12b and the respective end link 26, 28 maintain the corresponding relative orientation in a self-supporting manner, i.e. the connection members 16f, 17m and 16m, 17f define a rigid, non-rotatable connection between the arm 12a, 12b and the respective end link 26, 28.

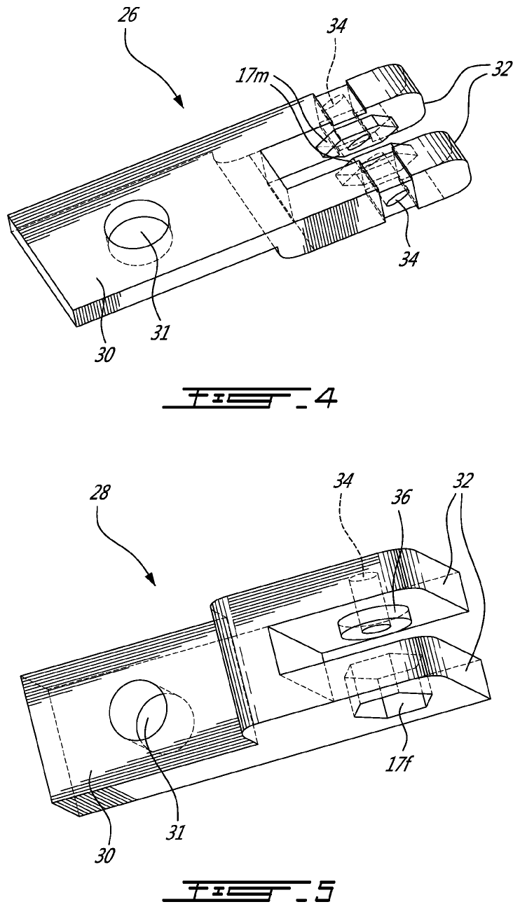

An exemplary embodiment for the male end link 26 is shown in FIG. 4. The connection flange 30 of the male end link 26 has a hole 31 defined therethrough, sized and configured to receive a fastener (not shown) engaging the male end link 26 to the respective element of the aircraft; any other configuration suitable for attachment may alternately be used. Two spaced apart fingers 32 extend from the connection flange 30, with a space between the fingers 32 being sufficient to receive the arm 12b between the fingers 32. Each finger 32 includes a male connection member 17m protruding toward the other finger 32, so as to engage the aperture of the female connection member 16f of the arm 12b; alternately, only one of the fingers 32 may include the male connection member 17m. Each male connection member(s) 17m of the end link 26 has a shape complementary to that of the female connection member 16f of the arm 12b, so as to be snuggly engageable therein in a non-rotatable manner. In the embodiment shown, the fingers 32 also each include a through hole 34 defined at the center of the male connection members 17m, the through holes 34 of the two fingers 32 being coaxial. A suitable fastener (not shown) may extend through the holes 34 and the female connection member 16f of the arm 12b so as to lock the end link 26 laterally in engagement with the arm 12b. In a particular embodiment, the fastener is a tie member similar to that used to attach the wire 8 to the arms 12a, 12b, for example a cable tie. Other configurations are also possible.

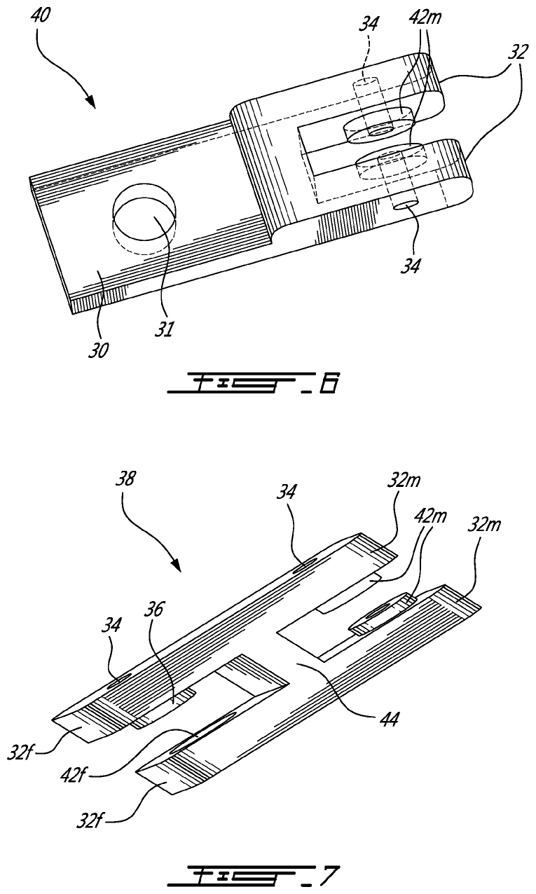

An exemplary embodiment for the female end link 28 is shown in FIG. 5, with elements similar to the male end link 26 being identified by the same reference numerals. In the female end link 28, at least one of the fingers 32 includes an aperture defined therethrough forming a female connection member 17f; the aperture may be a through aperture as shown, or may be defined as a blind recess, providing the aperture has a depth sufficient to receive the male connection member 16m of the arm 12a. Each female connection member 17f of the end link 28 has a shape complementary to that of the male connection member 16m of the arm 12a, so that the male connection member 16m of the arm can be snuggly received in the female connection member 17f of the end link 28 in a non-rotatable manner. The other finger 32 may include an abutment member 36 engageable in a complementary recess (not shown) defined in the surface of the arm 12a opposite the surface including the male connection member 16m, for example to provide a more stable connection; alternately, the abutment member 36 may be omitted. The finger(s) 32 not including a through aperture each have a through hole 34 aligned with the connection member, to be aligned with a similar through hole 34 defined at the center of the male connection member 16m of the arm 12b (see FIG. 3). A suitable fastener (e.g., cable tie, cutter pin) may extend through the holes 34 of the finger(s) 32 and arm 12a and through the female connection member 17f of the finger(s) 32 so as to lock the end link 28 laterally in engagement with the arm 12a.

It is understood that alternately, the two arms 12a, 12b may not be identical, and/or may include different types of connection members; the end links 26, 28 are accordingly configured to as to be able to engage the distal ends of the arms 12a, 12b while maintaining the relative orientation of the respective arm in a non-rotatable and self-supporting manner.

The end link(s) 26, 28 attached to the arms 12, 12b allow for installation of the wire brace 110, and the wire 8 engaged thereto, in a predetermined orientation with respect to the aircraft structure. The wire brace 110 thus maintains the predetermined radius of curvature R set during preforming throughout installation and use, while at the same time serving as a support to attach the wire 8 to the element(s) of the aircraft. In a particular embodiment, the wire brace 110 with the end links 26, 28 may be used as an adjustable longitudinal support for the wire 8.

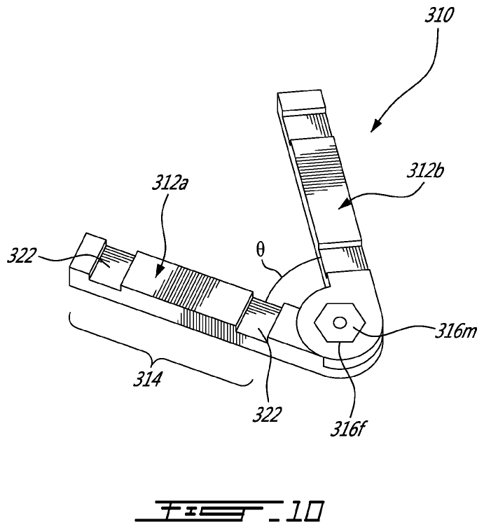

Referring to FIG. 9, in a particular embodiment the wire brace 210 is configured for uses other than maintaining a predetermined radius of curvature for the wire 8. The wire brace 210 includes the two arms 12a, 12b of the previously described wire braces 10, 110, which accordingly will not be described further herein. However, the engaged ends 20 of the arms 12a, 12b are not directly connected to each other, but are connected via an intermediate link 38 defining an articulated connection between the arms 12a, 12b allowing a continuous variation in a relative orientation of the arms 12a, 12b. In this embodiment the wire brace 110 also include a pivotable end link 40 pivotally connected to the distal end 18 of one of the arms 12b so as to define an articulated connection between that arm 12b and the element of the aircraft the end link 40 is connected to.

In this articulated embodiment, the wire 8 is secured to the engagement portion 14 of each of the arms 12a, 12b, but with the tie members 24 sufficiently loose so as to allow sliding of the wire 8 relative to the arms 12a, 12b along a longitudinal axis of the wire 8. The wire 8 has an overall length greater than a combined length of the arms 12a, 12b and of the links 38, 40, so as to define a loop 8′ of extra wire material between the arms 12a, 12b. In a particular embodiment, the wire brace 210 with the pivotable end link 40 and intermediate link 38 may be used as a service loop guide, e.g. to guide the extra wire material upon displacement of the wire 8, for example during maintenance.

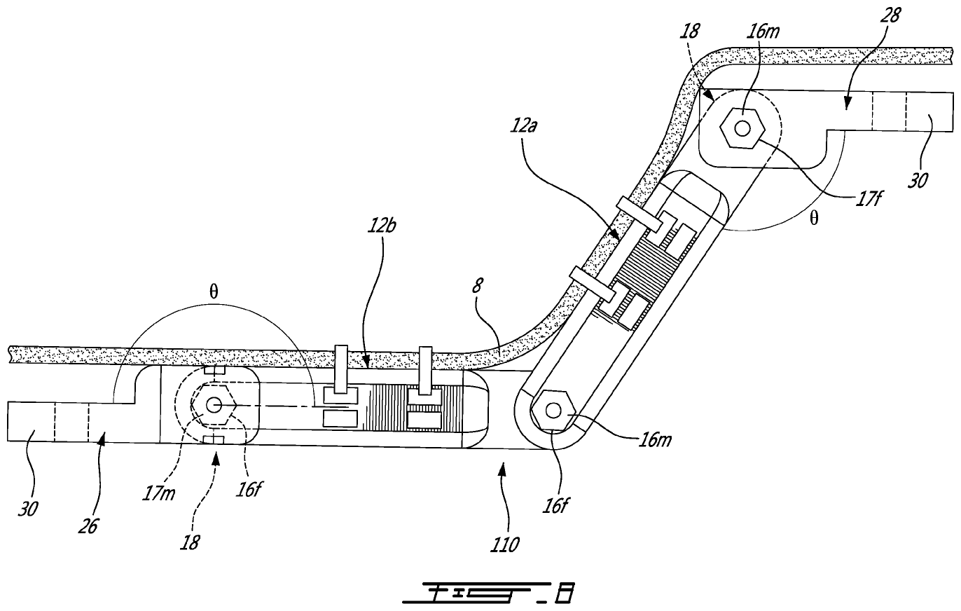

An exemplary embodiment for the pivotable end link 40 is shown in FIG. 6. The pivotable end link 40 includes a connection flange 30 configured for engagement to a respective element of the aircraft, similar to that of the end links 26, 28 described above, and an additional connection member 42m removably and pivotally connected to the connection member 16f of the respective arm 12b. In the embodiment shown, the pivotable end link 40 is connected to a female connection member 16f of one of the arms 12b. Accordingly, the two spaced apart fingers 32 extend from the connection flange 30 each include a male connection member 42m protruding toward the other finger 32, so as to engage the aperture of the female connection member 16f of the arm 12b; alternately, only one of the fingers 32 may include the male connection member 42m. Each male connection member 42m is configured so as to be rotatable within the female connection member 16f of the arm 12b. For example, in the embodiment shown, the male connection members 42m have a circular shape receivable and rotatable within the hexagonal shape of the female connection member 16f of the arm 12b. It is understood that alternately, the pivotable end link 40 may be connected to a male connection member 16m of one of the arms 12a, 12b, and accordingly may include a suitable female connection member allowing for rotation of the male connection member 16m therewithin.

In the embodiment shown, the fingers 32 also each include a through hole 34 defined at the center of the male connection members 42m, the through holes 34 of the two fingers 32 being coaxial. A suitable fastener (e.g., cable tie, cutter pin) or a suitable pivot may extend through the holes 34 and the female connection member 16f of the arm 12b so as to lock the end link 40 laterally in engagement with the arm 12b without impeding the relative rotation.

An exemplary embodiment for the intermediate link 38 is shown in FIG. 7. The intermediate link 38 includes a central portion 44 from which extend two opposed sets of spaced apart fingers 32f, 32m, each set being spaced apart a sufficient distance so as to be able to receive the end of the respective arm 12a, 12b between the fingers. One set of fingers 32m includes male connection member(s) 42m (one per finger 32m in the embodiment shown) to engage the female connection member 16f of one arm 12a, while the other set of fingers 32f include female connection member(s) 42f (one in the embodiment shown) to engage the male connection member 16m of the other arm 12b.

Similarly to the pivotable end link 40, the male connection members 42m of the intermediate link 38 are configured so as to be rotatable within the female connection member 12f of the respective arm 12a. For example, in the embodiment shown, the male connection members 42m of the intermediate link 38 have a circular shape receivable and rotatable within the hexagonal shape of the female connection member 16f of the arm 12a.

The female connection member 42f defined in one of the fingers 32f is also configured so that the male connection member 16m of the respective arm 12m is rotatable therewithin. For example, in the embodiment shown, the female connection member 42f of the intermediate link 38 has a circular shape in which the hexagonal shape of the male connection member 16m of the arm 12b is receivable and rotatable. The other finger 32f may include an abutment member 36 engageable in a complementary recess (not shown) defined in the surface of the arm opposite the surface including the male connection member 16m.

In the embodiment shown, the sets of fingers 32m, 32f also each include a through hole 34 defined at the center of the connection members 42m, 42f, the through holes 34 of the two fingers 32m, 32f of the same set being coaxial. A suitable fastener (e.g., cable tie, cutter pin) or a suitable pivot may extend through the holes 34 and the connection member 16f, 16m and/or hole 34 of the respective arm 12a, 12b so as to lock the intermediate link 38 laterally in engagement with the respective arm 12a, 12b without impeding the relative rotation.

Referring to FIG. 10, a wire brace 310 in accordance with another embodiment is shown. In this embodiment, each arm 312a, 312b includes a single connection member 316f, 316m, complementary to the connection member 316f, 316m of the other arm. For example, in the embodiment shown, one of the arms 312a includes a male connection member 316m while the other arm 312b includes a female connection member 316f snuggly receiving the male connection member 316m in a non-rotatable manner. The connection members 316f, 316m are removably engageable with each other in at least two, and in a particular embodiment more than two, different configurations, with each configuration defining a different angle 8 between the two arms 312a, 312b. In each configuration, the two arms 312a, 312b maintain the corresponding relative orientation, i.e. the connection members 316f, 316m define a rigid, non-rotatable connection between the two arms 312a, 312b in a self-supporting manner. In the embodiment shown, the male and female connection members 316f, 316m have a hexagonal shape. The engagement portion 314 of each arm 312a, 312b includes two notches 322 spaced apart along a longitudinal direction of the arm 312a, 312b, sized and shaped to receive a suitable tie member (not shown) extending around the arm 312a, 312b and the wire together.

It is understood that the particular configurations shown for the arms 12a, 12b, 312a, 312b are exemplary only, and that other suitable configurations may be used.

Although the present wire brace 10, 110, 210, 310 has been described and discussed in the context of an aircraft, it is understood that the wire brace 10, 110, 210, 310 may also be used to support a wire in any other suitable type of installation where wires have a curved path and need to maintain a radius of curvature greater than a minimum value, and/or where guidance is desirable for service loops in the wire, including, but not limited to, in other types of vehicles.

While the methods and systems described herein have been described and shown with reference to particular steps performed in a particular order, it will be understood that these steps may be combined, sub-divided or reordered to form an equivalent method without departing from the teachings of the present invention. Accordingly, the order and grouping of the steps is not a limitation of the present invention.

The above description is meant to be exemplary only, and one skilled in the art will recognize that changes may be made to the embodiments described without departing from the scope of the invention disclosed. Modifications which fall within the scope of the present invention will be apparent to those skilled in the art, in light of a review of this disclosure, and such modifications are intended to fall within the appended claims.

1. A wire brace comprising:
a first arm including a first engagement portion configured to be secured to a wire, the first arm having an end including a first connection member;
a second arm including a second engagement portion configured to be secured to the wire, the second arm having an end including a second connection member complementary to the first connection member;
wherein the first and second connection members are removably engageable to each other in at least first and second alternate configurations, wherein in the first configuration, the first and second arms maintain a relative orientation at a first angle from each other, and in the second configuration, the first and second arms maintain a relative orientation at a second angle from each other, the second angle being different from the first angle.

2. The wire brace as defined in claim 1, wherein the first and second arms are identical to each other.

3. The wire brace as defined in claim 1, wherein the first and second connection members are complementary shaped so as to define a non-rotatable engagement.

4. The wire brace as defined in claim 3, wherein the first connection member is a female connection member and the second connection member is a male connection member, the male and female connection members having a polygonal shape.

5. The wire brace as defined in claim 1, wherein:
the first arm has an opposed end including a third connection member identical to the second connection member of the second arm; and
the second arm has an opposed end including a fourth connection member identical to the first connection member of the first arm.

6. The wire brace as defined in claim 5, further comprising an end link including a connection flange, the end link having an additional connection member removably engageable to the third connection member in at least first and second alternate link configurations, wherein in the first link configuration, the first arm maintains a relative orientation at a third angle from the connection flange, and in the second link configuration, the first arm maintains a relative orientation at a fourth angle from the connection flange, the third angle being different from the fourth angle.

7. The wire brace as defined in claim 1, wherein the first engagement portion is defined by a portion of the first arm having at least two longitudinally spaced apertures extending therethrough, the second engagement portion is defined by a portion of the second arm having at least two longitudinally spaced apertures extending therethrough, the first and second engagement portions each further comprising a respective tie member looped through each aperture for surrounding the wire.

8. An assembly including the wire brace as defined in claim 1 with the first and second connection members engaged to each other in the first configuration, and further comprising a wire secured to the first and second engagement portions, the wire brace maintaining a predetermined radius of curvature in a portion of the wire proximate the first and second connection members.

9. A wire brace including two arms connected to each other, the arms being identical to each other, each of the arms comprising:
a first end having a first connection member;
a second end opposed to the first end, the second end having a second connection member complementary to the first connection member; and
an engagement portion intermediate the first and second ends, the engagement portion including at least one tie member configured to surround and engage a wire.

10. The wire brace as defined in claim 9, wherein the first connection member is a female connection member and the second connection member is a male connection member, the male and female connection members having a polygonal shape.

11. The wire brace as defined in claim 9, wherein each of the at least one tie member is looped through at least one respective aperture defined through the arm.

12. The wire brace as defined in claim 9, wherein the arms are directly connected to each other, the first connection member of a first one of the arms and the second connection member of a second one of the arms being removably engaged to each other with the arms maintaining a relative orientation at a first angle from each other, and wherein the first connection member of the first one of the arms and the second connection member of the second one of the arms are engageable to each other in an alternate configuration with the arms maintaining a relative orientation at a second angle from each other, the second angle being different from the first angle.

13. The wire brace as defined in claim 12, wherein the first and second connection members are complementary shaped so as to define a non-rotatable engagement.

14. The wire brace as defined in claim 12, further comprising an end link including a connection flange, the end link having an additional connection member removably engaged to the second connection member of the first one of the arms with the first one of the arms maintaining a relative orientation at a third angle from the connection flange, and wherein the end link is removably engageable to the second connection member of the first one of the arms in an alternate configuration with the first one of the arms maintaining a relative orientation at a fourth angle from the connection flange, the fourth angle being different from the third angle.

15. An assembly including the wire brace as defined in claim 12, further comprising a wire secured to the engagement portion of each one of the arms, the wire brace maintaining a predetermined radius of curvature in a portion of the wire proximate the first connection member of the first one of the arms and the second connection member of the second one of the arms.

16. The wire brace as defined in claim 9, wherein the arms are connected to each other via an intermediate link including third and fourth connection members spaced apart from each other, the third connection member being pivotally and removably engaged to the first connection member of a first one of the arms, the fourth connection member being pivotally and removably engaged to the second connection member of a second one of the arms, the intermediate link defining an articulated connection between the arms allowing a variation in a relative orientation of the arms.

17. The wire brace as defined in claim 16, further comprising an end link including a connection flange, the end link having an additional connection member pivotally and removably engaged to the second connection member of the first one of the arms, wherein the end link is configured to define an articulated connection allowing a variation in a relative orientation of the first one of the arms with respect to the connection flange.

18. The wire brace as defined in claim 16, wherein the first connection member is a female connection member and the second connection member is a male connection member, the first and second connection members having a similar polygonal shape, and wherein the third connection member is a male connection member and the fourth connection member is a female connection member, the third and fourth connection members having a circular shape.

19. An assembly including the wire brace as defined in claim 16, and further comprising a wire secured to the engagement portion of each of the arms so as to allow a relative sliding movement of the wire along a longitudinal axis of the wire, the wire having an overall length greater than a combined length of the arms and of the intermediate link, the wire defining a loop of extra wire material between the arms.

20. A method of maintaining a predetermined radius of curvature in a wire, the method comprising:
preforming the wire to include a curved section having the predetermined radius of curvature, including engaging the wire to a brace maintaining the predetermined radius of curvature in a self-supporting manner;
installing the wire while the wire remains engaged to the brace; and
leaving the wire engaged to the brace during use of the wire.

21. The method as defined in claim 20, wherein installing the wire includes attaching the brace to an element adjacent the installed wire.
